(19) United States
(12) Patent Application Publication
(10) Pub. No.: US 2008/0275702 A1
(43) Pub. Date: Nov. 6, 2008

(54) System and method for providing digital dictation capabilities over a wireless device

(75) Inventors: Simon John Lewis, Kent (GB); Graham Wright, London (GB); Marc Stuart Harris, London (GB); David Fryer, Herts (GB); Jonathan Mark Isherwood Carter, Kent (GB); James Shannon, Winchester (GB); Robert Bakewell, Wiltshire (GB); Jonathan Fisher, Manchester (GB)

Correspondence Address: DRINKER BIDDLE & REATH (DC), 1500 K STREET, N.W., SUITE 1100, WASHINGTON, DC, 20005-1209, US

(73) Assignee: BigHand Ltd.

(21) Appl. No.: 12/149,465

(22) Filed: May 1, 2008

Related U.S. Application Data
(60) Provisional application No. 60/924,156, filed on May 2, 2007.

(51) Int. Cl. G10L 15/26

(52) U.S. Cl. 704/235; 704/E15.001

(57) ABSTRACT

A system and method for providing digital dictation capabilities over a wireless device. The system and method enables digital dictations to be recorded on a wireless device, such as a BlackBerry smartphone, and then uploaded wirelessly to a remote location, such a server, for transcription. Features of the wireless device, such as the display and trackball, can be used to control the dictation.

This application claims benefit from U.S. Provisional Patent Application Ser. No. 60/924,156, filed on May 2, 2007, the entire contents of which being incorporated herein by reference.

### BACKGROUND OF THE INVENTION

1. Field of the Invention

The present invention relates to a system and method for providing digital dictation capabilities over a wireless device. More particularly, the present invention relates to a system and method which enables digital dictations to be recorded on a wireless device, such as a BlackBerry smartphone, and then uploaded wirelessly for transcription.

2. Description of the Related Art

Traditionally, magnetic tapes have been used for dictation. Advances in computer and software technology have made it possible to record voice in a computer readable file, such as a .wav file. The dictated files can be copied into network folders or emailed as attachments for access by transcribers. Alternatively, authors can physically transfer memory cards to transcribers.

Although these techniques may be somewhat suitable, it is desirable to develop more effective and efficient manners for handling dictation.

### BRIEF DESCRIPTION OF THE DRAWINGS

Objects, advantages and novel features of the invention will be more readily appreciated from the following detailed description when read in conjunction with the accompanying drawings, in which:

FIG. 1 is a conceptual diagram illustrating an example of a network employing a system and method for providing digital dictation capabilities over a wireless device;

FIG. 2 is a conceptual diagram illustrating an example of another network employing a system and method for providing digital dictation capabilities over a wireless device; and

FIG. 3 is a more detailed illustration of an example of a wireless device as shown in FIG. 1.

### DETAILED DESCRIPTION OF THE EMBODIMENTS

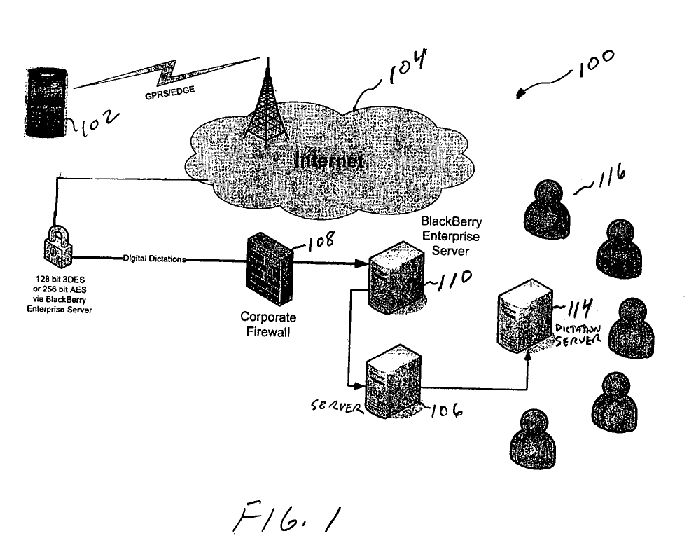

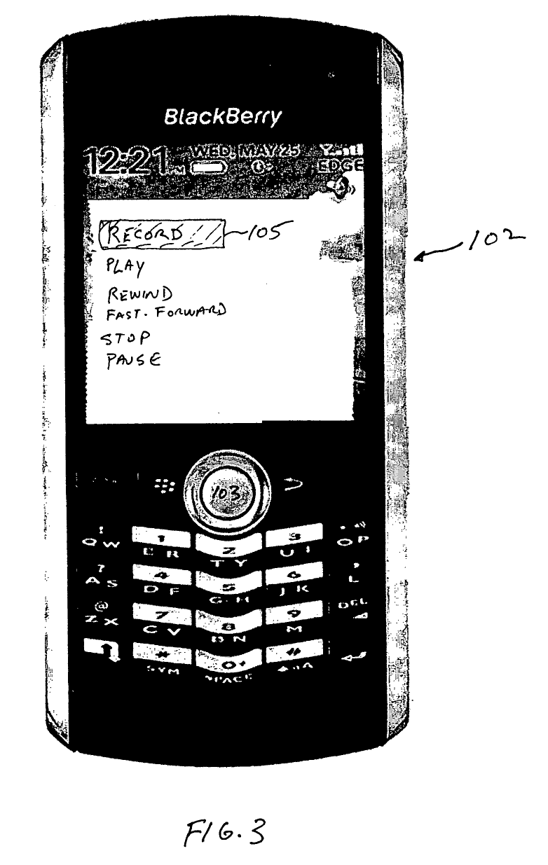

As shown in FIG. 1, a network 100 employing a system and method according to an embodiment of the present invention is capable of communicating with remote wireless devices 102, such as a BlackBerry or any personal digital assistant (PDA), that has telephony and email capabilities. In this example, the device 102 illustrated is a BlackBerry smartphone, and is referred to herein as a “device 102”, “devices 102” “BlackBerry smartphone 102” or “Blackberry smartphones 102.” The system and method according to the embodiments of the present invention described herein is usable with as many devices 102 for which the network 100 can provide service. As further indicated, the devices 102 can communicate with the Internet 104 via GPRS (General Packet Radio Service), EDGE (Enhanced Data Rates For GSM (Global System for Mobile Communication) Evolution), a wireless Internet connection or through a connection to a computer which is connected to the Internet 104; and via any technologies as can be understood by one skilled in the art. The Digital Dictation Application can be installed onto the BlackBerry smartphone 102 (or other type of device) over-the-air from, for example, a website such or from a BlackBerry Enterprise Server 110. The application can also be installed from a PC (personal computer), or in any other suitable manner. Once installed, the Digital Dictation application enables a user of the device 102 to record, edit and upload dictations for transcription from any location where there is wireless coverage for the device 102 or a computer connected to the Internet. The application can use a simple and intuitive interface that takes advantage of the latest BlackBerry hardware features such as the trackball 103 (see FIG. 3) and side convenience keys, and the user is informed of the recording mode through the use of, for example, the built-in LED and vibration notifications of the device 102.

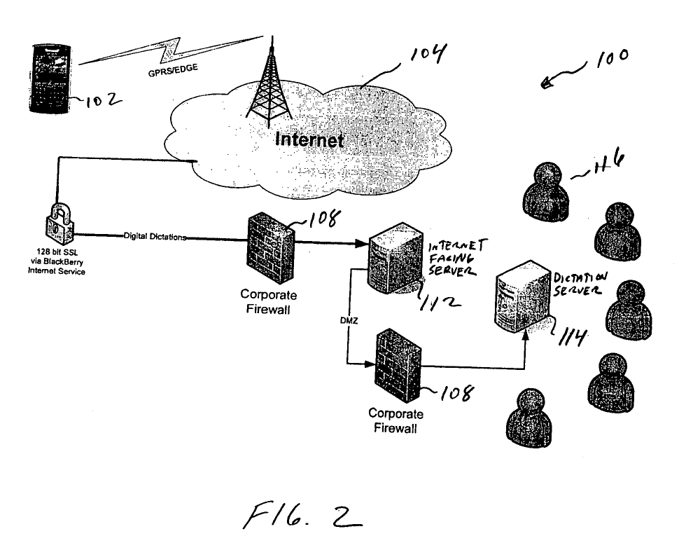

The Digital Dictation Bridge software is an additional component that can be installed, for example, on a server 106 inside the company's network (e.g., inside the corporate firewall 108), for use with a BlackBerry Enterprise Server 110 as understood by one skilled in the art. Alternatively, the Digital Dictation Bridge software can be installed on an internet-facing server 112 as shown in FIG. 2 if, for example, the company is using BlackBerry Internet Service. In the arrangements shown in FIG. 1 and FIG. 2, the dictation bridge receives the digital dictations from the devices 102 (e.g., the BlackBerry smartphones) together with information pertaining to the author, subject, priority and destination and passes them directly into the digital dictation server 114. User authentication can be automatic if a BlackBerry Enterprise Server 110 is used, or authentication can be performed in relation to, for example, a Microsoft Active Directory if BlackBerry Internet Service is being used, with the user's email address and password having been configured in the Digital Dictation application.

The Digital Dictation Bridge software can be activated using a license that is configured for the number of BlackBerry smartphones 102 that will be used to record and upload dictations through the Digital Dictation Bridge software. Additional device licenses may, for example, be purchased at any time and the Dictation Bridge license file can thus be replaced. At least an outbound-only http connection via the Internet 104 to the Licensing Server (not shown) can be used in order to activate a Digital Dictation Bridge software license key and to provide ongoing device and feature license updates.

Once the dictation files have been sent to the dictation server 114, transcribers 116 such as secretaries, word processing personnel and so on, can listen to the files and transcribe the audio files into written text.

File Formats

In this example, the Digital Dictation application on a device 102 (e.g., BlackBerry smartphone) records an audio using a file format based on AMR (adaptive multi-rate) Narrow Band at 12.2 Kbps. AMR-NB is extremely efficient and takes advantage of the voice processing hardware inherent in, for example, every BlackBerry smartphone. AMR-NB uses approximately 90 Kilobytes of storage per minute of dictation, and is therefore well suited to the constraints of both on-device storage and wireless transmission. However, certain BlackBerry smartphones support removable microSD storage cards that allow many hours of dictation to be stored on the smartphone prior to upload if required.

Security

As can be appreciated by one skilled in the art, the BlackBerry wireless solution is world-renowned for providing high security communication, and these capabilities can be fully exploited when utilizing BlackBerry smartphones as the devices 102 for digital dictation. In a BlackBerry Enterprise Server environment as shown in FIG. 1, the wireless connection between every BlackBerry smartphone 102 and the BlackBerry enterprise server 108 is encrypted using, for example, 128 bit Triple DES (data encryption standard) or 256 bit AES (advanced encryption standard) encryption. In the BlackBerry Internet Service arrangement as shown in FIG. 2, the Digital Dictation application may instead use an https server protected by, for example, 128 bit SSL (secure sockets layer) security, thereby protecting the dictation in transit over the Internet 104. Security can be further enhanced by configuring the microSD card on the BlackBerry smartphone to encrypt its contents based on the unique identity of the device 102, the user's password or both. This can ensure that all digital dictations remain secure in the event that a storage card is mislaid. BlackBerry Enterprise users have additional security because their device may be remotely wiped and disabled by their administrator if the device itself is lost or stolen.

Optimal Connectivity Ensured

Whatever connectivity model is employed in the network 100, the Digital Dictation application can automatically detect the options available on the device 102 and select the most optimal and secure route for the digital dictation transmission to the dictation server 114. The BlackBerry Enterprise Server 110, BlackBerry Internet Service and Direct TCP transmission modes are supported, with dictation uploads included in existing BlackBerry data subscriptions where supported by local carriers. Furthermore, the upload protocols contained in the Digital Dictation application can ensure that dictations are transmitted in the optimum way for the automatically chosen BlackBerry transport.

Device Manageability

The Digital Dictation application also leverages the built-in IT Policy features of BlackBerry Enterprise Server 110, which allows the BlackBerry Enterprise Server Administrator to pre-configure, deploy and upgrade large numbers of BlackBerry smartphones 102 using IT policies based on individuals or groups of users. This can be critical in an environment when many devices must be managed, and can ensure that both application configuration, maintenance and support tasks are minimized. Managing a deployment of BlackBerry smartphones 102 configured with the Digital Dictation application will therefore be a familiar task for any BlackBerry Enterprise Server administrator.

Minimum System Requirements

The Digital Dictation application in this example is useable with a device 102 having a BlackBerry OS 4.2.1 or higher. This includes the BlackBerry 8800 smartphone and any previous model that has been upgraded to OS 4.2.1. The Digital Dictation Bridge software in this example is useable with Internet Information Services 6.0 with ASP.NET on a Windows Server 2003 Web Edition server (or higher) and may utilize a smaller digital dictation server 114 in smaller BlackBerry Enterprise Server deployments. A separate dictation bridge server is can be used for large BlackBerry Enterprise Server deployments and for BlackBerry Internet Service deployments when, for example, the server should be located in the DMZ (demilitarized zone) of an Internet-facing architecture as shown, for example, in FIG. 2.

Additional Features

The Digital Dictation Application discussed above can further include additional User Interface features, advanced recording ability featuring overwrite functionality and enhanced stability using handlers for low memory situations, incoming phone calls and BlackBerry file system errors. In addition the original Digital Dictation Bridge was replaced by the BigHand BlackBerry Gateway.

User Interface

The Digital Dictation Application can employ a user interface which makes use of the BlackBerry smartphone form factor to provide a similar interaction to traditional Dictaphones. The BlackBerry trackball 103 or trackwheel can be used to control the recording state (for example, play, stop, record, rewind, fast-forward, pause and so on), and, as shown in FIG. 3, each state (e.g., record in this example) is activated when given focus (e.g., when the trackball 103 is used to move the highlight 105 over the desired state) rather than requiring a “click.” This allows users to “slide” between states, akin to the slider on a Dictaphone.

To prevent users from selecting the wrong recording state accidentally, the Digital Dictation application can enforce a short pause between movements of the trackball or trackwheel and recording buttons are disabled if their purpose would be inappropriate to the application's context at any time.

Advanced Recording Ability

The Digital Dictation Application further allows users to rewind and overwrite their recordings, thus emulating behavior which is standard for analogue cassettes but is not available on a conventional BlackBerry smartphone. This functionality can be achieved by, for example, using extensive wrapping and processing of the BlackBerry API (Application Programming Interface) which otherwise (i.e., without the enhanced functionality provided by the Digital Dictation Application) gives very limited recording functionality.

Enhanced Stability

The stability of the Digital Dictation Application can further be enhanced by gracefully halting recording if the BlackBerry device enters a low memory state, is receiving an incoming phone call, or is approaching storage limits. For example, the Digital Dictation application monitors the storage space available on the device and warns the user when the space is becoming low. When storage becomes critical, the Digital Dictation Application can prevent the user from recording further dictation in order to safeguard the device. The base file system API can be wrapped to halt recording when the maximum resource limit for files being written to the device's main memory (as opposed to a secondary storage location such as an SD card) is approached. Hence, this functionality of monitoring the battery state and stopping dictation when the device enters a low battery state, as provided by the Digital Dictation Application, can prevent the BlackBerry device from becoming unstable.

In addition, the Digital Dictation Application handles telephone calls being received whilst a user is recording a dictation by, for example, pausing the recording automatically and allowing the user to receive the telephone call. When the call has ended, the user is returned to the recording screen and can continue recording.

BlackBerry Gateway

The Digital Dictation Bridge can be replaced by a BlackBerry Gateway. The BlackBerry Gateway can retain all the original functionality discussed above, but can integrate licensing into the central Dictation Server 114 and provide a base for the enhanced communication between the Digital Dictation Application and Digital Dictation Server 114.

In addition, as discussed below, the Digital Dictation Application can contain insert functionality during recording, and closer integration into the Digital Dictation Server 114. This integration enables status information to be obtained for dictations submitted from the BlackBerry device and the options for handling those dictations to be selected from those provided by the Digital Dictation Server 114.

Advanced Recording Ability

The Digital Dictation Application allows users to rewind their dictations and insert audio into the same, leaving the original recording intact. This functionality can be achieved by, for example, using extensive wrapping and processing of the BlackBerry API (Application Programming Interface) which otherwise (i.e., without the enhanced functionality provided by the Digital Dictation Application) gives very limited recording functionality. The Digital Dictation Application can further perform algorithms to intercept and modify sound streams and enable reconstruction of a single dictation file from the original and inserted audio.

Dictation Options

The Digital Dictation application allows users to assign a priority to dictation files so that transcriptionists are aware of the importance of each dictation and can process them accordingly. The assigned priority is associated with the dictation and is seen by users connected to the Dictation Server 114.

The Digital Dictation Application allows users to select a destination for their dictation, such destination being configured in the dictation system. The Digital Dictation application synchronises with the Dictation Server 114 to retrieve a list of destinations for the specific user. The synchronization can employ, for example, a combination of RIM's (Research in Motion), MDS (Mobile Data Services) and Microsoft's WCF (Windows Communication Foundation). Furthermore, the BlackBerry Gateway can operate to communicate with the central Digital Dictation system using WCF. The Digital Dictation Application further includes algorithms which provide for the integration of the BlackBerry and Microsoft APIs.

Dictation Status Updates

In addition, users are able to receive updates on dictations which are sent from the Digital Dictation Application to the dictation system and from such updates, the users are able to tell whether the dictation is pending, in progress or complete and which transcriptionist is working on the dictation. The synchronization of dictation status can employ a combination of MDS and WCF.

Although only a few exemplary embodiments of the present invention have been described in detail above, those skilled in the art will readily appreciate that many modifications are possible in the exemplary embodiments without materially departing from the novel teachings and advantages of this invention. For example, the order and functionality of the steps shown in the processes may be modified in some respects without departing from the spirit of the present invention. Accordingly, all such modifications are intended to be included within the scope of this invention.

What is claimed is:

1. A method for providing digital dictation using a wireless device, the method comprising:
operating the wireless device to record audio dictation and store the recorded dictation as a digital file in a memory at the wireless device;
operating the wireless device to transmit the stored digital file wirelessly to a location remote from the wireless device; and
storing the transmitted digital file at the remote location.

2. A method as claimed in claim 1, wherein the wireless device is a personal digital assistant having telephony functionality.

3. A method as claimed in claim 1, further comprising:
controlling the wireless device to perform at least one of the following functions: play back the stored digital file as audio; stop playback of the recorded stored digital file; stop recording of the audio dictation; continue recording the audio dictation; rewind to a location in the digital file for play back or editing; fast-forward to a location in the digital file for play back or editing; pausing play back or recording of the digital file.

4. A method as claimed in claim 3, wherein:
the wireless device includes a display screen and a trackball; and
the step of controlling the wireless device includes operating the trackball to position a highlighted cursor on the display screen on displayed text representing one of said functions to select that function to control the wireless device to perform that function.

5. A method as claimed in claim 1, further comprising operating the wireless device to perform at least one of the following functions:
monitoring an amount of available storage space in the memory and issuing an alert when the amount of available storage space decreases below a predetermined level; and
monitoring an amount of charge remaining in a power supply of the wireless device and issuing an alert when the amount of charge decreases below a predetermined level.

6. A method as claimed in claim 1, wherein:
the step of operating the wireless device to transmit the stored digital file includes transmitting the stored digital file wirelessly from the wireless device to an Internet interface for delivery via the Internet to a server at the remote location.

7. A method as claimed in claim 1, further comprising:
sending a status message to the wireless device identifying one of the following: the stored digital file at the remote location is awaiting transcription; the stored digital file at the remote location is undergoing transcription; and transcription of the stored digital file at the remote location is completed.

8. A system for performing digital dictation, comprising:
a wireless device for recording audio dictation, the wireless device comprising a memory for storing the received dictation as a digital file, and a transmitter for transmitting the stored digital file wirelessly to a location remote from the wireless device.

9. A system as claimed in claim 8, further comprising:
a storage device at the remote location for storing the transmitted digital file.

10. A system as claimed in claim 8, wherein the wireless device is a personal digital assistant having telephony functionality.

11. A system as claimed in claim 8, wherein:
the wireless device is operable to perform at least one of the following functions: play back the stored digital file as audio; stop playback of the recorded stored digital file; stop recording of the audio dictation; continue recording the audio dictation; rewind to a location in the digital file for play back or editing; fast-forward to a location in the digital file for play back or editing; pausing play back or recording of the digital file.

12. A system as claimed in claim 11, wherein:
the wireless device includes a display screen and a trackball which positions a highlighted cursor on the display screen on displayed text representing one of said functions to select that function to control the wireless device to perform that function.

13. A system as claimed in claim 8, wherein the wireless operates device to perform at least one of the following functions:
monitoring an amount of available storage space in the memory and issuing an alert when the amount of available storage space decreases below a predetermined level; and
monitoring an amount of charge remaining in a power supply of the wireless device and issuing an alert when the amount of charge decreases below a predetermined level.

14. A system as claimed in claim 8, wherein:
the wireless device transmits the stored digital file wirelessly to an Internet interface for delivery via the Internet to a server at the remote location.

15. A system as claimed in claim 14, wherein:
the server sends a status message to the wireless device identifying one of the following: the stored digital file at the remote location is awaiting transcription; the stored digital file at the remote location is undergoing transcription; and transcription of the stored digital file at the remote location is completed.

16. A computer-readable medium of instructions for controlling a wireless device to record digital dictation, the instructions comprising:
a first set of instructions for controlling the wireless device to record audio dictation and store the recorded dictation as a digital file in a memory at the wireless device; and
a second set of instructions for controlling the wireless device to transmit the stored digital file wirelessly to a location remote from the wireless device.

17. A computer-readable medium of instructions as claimed in claim 16, wherein the wireless device is a personal digital assistant having telephony functionality.

18. A computer-readable medium of instructions as claimed in claim 16, further comprising:
a third set of instructions for controlling the wireless device to perform at least one of the following functions: play back the stored digital file as audio; stop playback of the recorded stored digital file; stop recording of the audio dictation; continue recording the audio dictation; rewind to a location in the digital file for play back or editing; fast-forward to a location in the digital file for play back or editing; pausing play back or recording of the digital file.

19. A computer-readable medium of instructions as claimed in claim 18, wherein:
the wireless device includes a display screen and a trackball; and
the third set of instructions controls the wireless device to position a highlighted cursor on the display screen on displayed text representing one of said functions to select that function to control the wireless device to perform that function in response to movement of the trackball.

20. A computer-readable medium of instructions as claimed in claim 16, further comprising a fourth set of instructions for controlling the wireless device to perform at least one of the following functions:
monitoring an amount of available storage space in the memory and issuing an alert when the amount of available storage space decreases below a predetermined level; and
monitoring an amount of charge remaining in a power supply of the wireless device and issuing an alert when the amount of charge decreases below a predetermined level.
